(19) United States
(12) Patent Application Publication
(10) Pub. No.: US 2019/0118075 A1
(43) Pub. Date: Apr. 25, 2019

(54) Sports Agility Game

(71) Applicant: Brian Becker, Castle Rock, CO (US)

(72) Inventor: Brian Becker, Castle Rock, CO (US)

(21) Appl. No.: 15/789,689

(22) Filed: Oct. 20, 2017

(51) Int. Cl. A63F 7/30; G09B 19/00; A63B 67/06; A63B 67/00

(52) U.S. Cl. CPC A63F 7/30; G09B 19/00; A63B 2022/0092; A63B 67/002; A63B 67/06

(57) ABSTRACT

A sports agility game for training hand eye coordination includes a base that may be positioned on a support surface. A box is pivotally coupled to the base such that the box is selectively positioned at a selected angle. A plurality of pegs is provided and each of the pegs is selectively inserted into a selected one of the apertures in the box. A ball is provided and the ball is selectively thrown against the box. The ball is comprised of a resiliently compressible material such that the ball bounces from the box. The ball randomly strikes the pegs that are positioned on the box thereby altering an angle of deflection of the ball with respect to the box. In this way the pegs inhibit the user from guessing the angle of deflection of the ball thereby enhancing hand eye coordination.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98.

The disclosure and prior art relates to agility devices and more particularly pertains to a new agility device for training hand eye coordination.

### BRIEF SUMMARY OF THE INVENTION

An embodiment of the disclosure meets the needs presented above by generally comprising a base that may be positioned on a support surface. A box is pivotally coupled to the base such that the box is selectively positioned at a selected angle. A plurality of pegs is provided and each of the pegs is selectively inserted into a selected one of the apertures in the box. A ball is provided and the ball is selectively thrown against the box. The ball is comprised of a resiliently compressible material such that the ball bounces from the box. The ball randomly strikes the pegs that are positioned on the box thereby altering an angle of deflection of the ball with respect to the box. In this way the pegs inhibit the user from guessing the angle of deflection of the ball thereby enhancing hand eye coordination.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a sports agility game according to an embodiment of the disclosure.

FIG. 2 is a top phantom view of an embodiment of the disclosure.

FIG. 3 is a first side phantom view of an embodiment of the disclosure.

FIG. 4 is a perspective view of pegs and a ball of an embodiment of the disclosure.

FIG. 5 is a perspective in-use view of an embodiment of the disclosure.

### DETAILED DESCRIPTION OF THE INVENTION

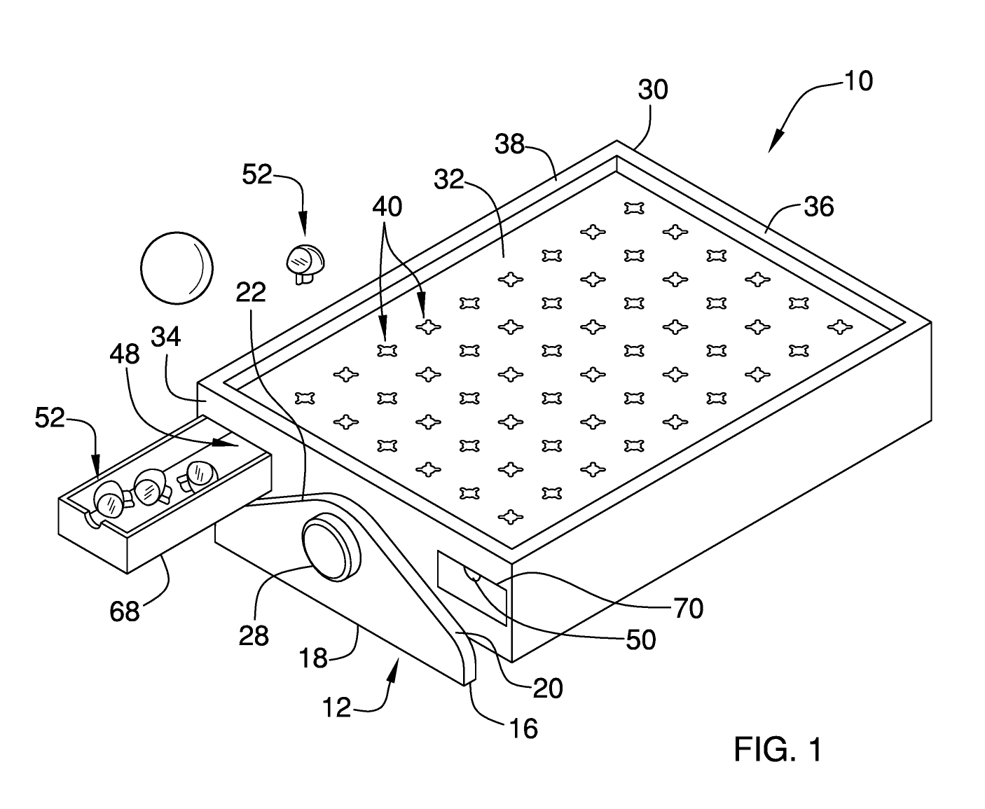

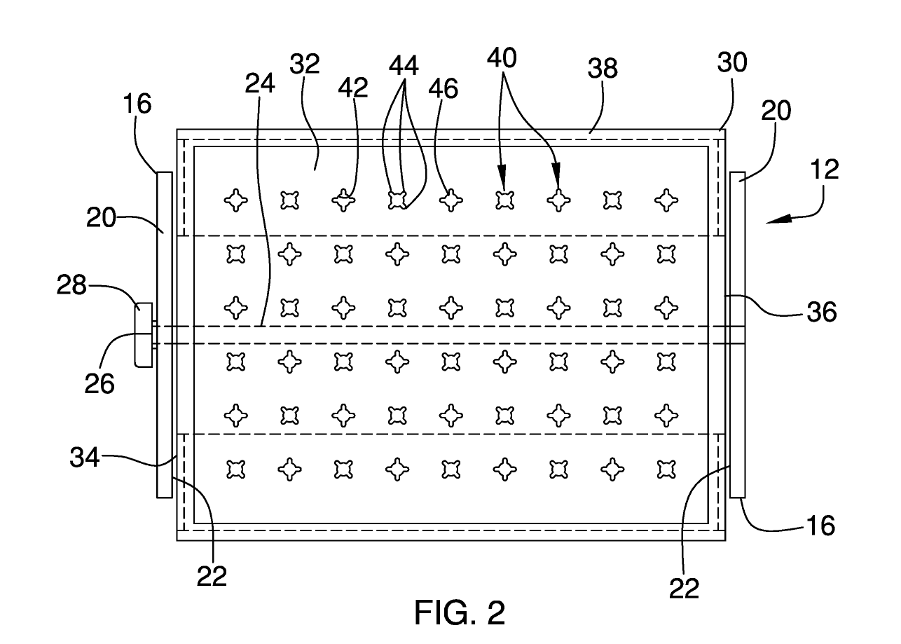

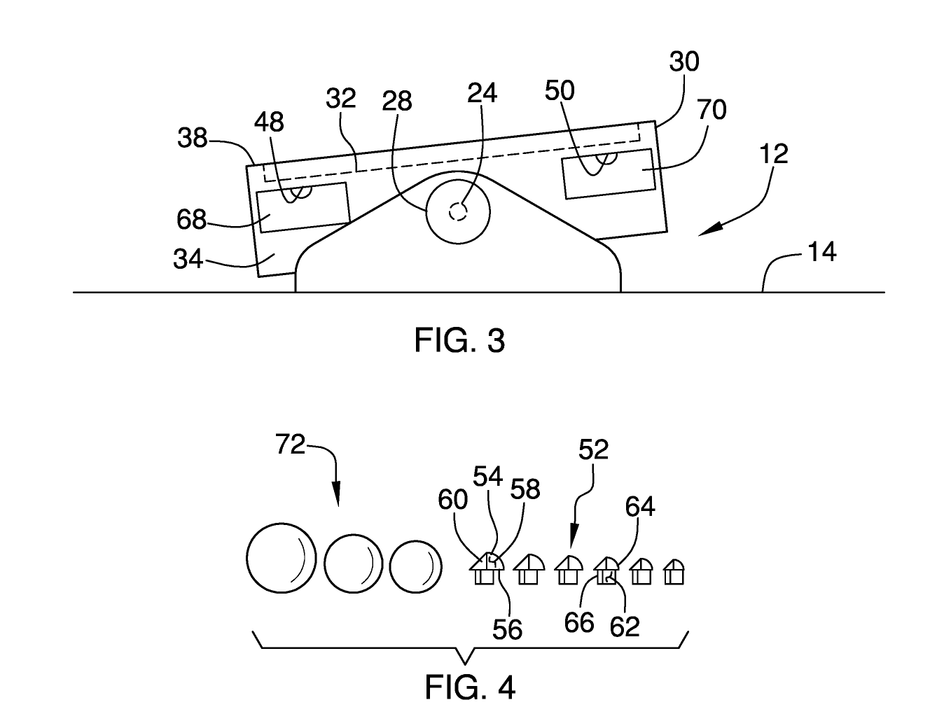

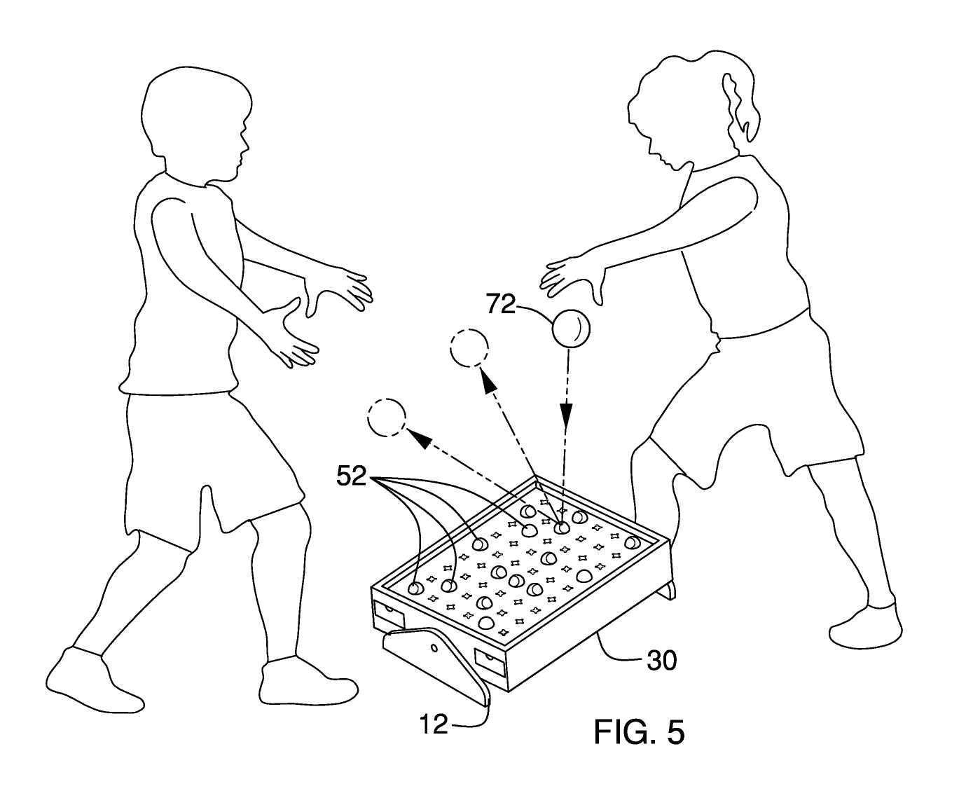

With reference now to the drawings, and in particular to FIGS. 1 through 5 thereof, a new agility device embodying the principles and concepts of an embodiment of the disclosure and generally designated by the reference numeral 10 will be described.

As best illustrated in FIGS. 1 through 5, the sports agility game 10 generally comprises a base 12 that may be positioned on a support surface 14 such as ground or the like. The base 12 includes a pair of feet 16 and each of the feet 16 has a bottom edge 18, a top edge 20 and a first surface 22. The bottom edge 18 corresponding to each of the feet 16 abuts the support surface 14. The top edge 20 corresponding to each of said feet 16 slopes downwardly toward the bottom edge 18 from a center of the corresponding foot 16 such that each of said feet 16 has a triangular shape.

A rod 24 rotatably extends through each of the feet 16 such that the feet 16 are spaced apart from each other. The first surface 22 corresponding to each of the feet 16 is directed toward each other. The rod 24 has a first end 26 and the rod 24 extends through an associated one of the feet 16 such that the first end 26 is exposed. A knob 28 is threadably coupled to the first end 26 of the rod 24 and the knob 28 is selectively manipulated. The knob 28 frictionally engages the associated foot 16 when the knob 28 is tightened thereby retaining the rod 24 at a selected point of rotation in the feet 16.

A box 30 is pivotally coupled to the base 12 such that the box 30 is selectively positioned at a selected angle. The box 30 has a top side 32, a first lateral side 34 and a second lateral side 36. The top side 32 is recessed to define a lip 38 extending around the perimeter of the top side 32. Moreover, the top side 32 has a plurality of apertures 40 extending into an interior of the box 30. The apertures 40 are spaced apart from each other and are distributed on the box 30. Each of the apertures 40 has a bounding surface 42 and the bounding surface 42 corresponding to each of the apertures 40 undulates to define a plurality of arms 44 and a circle 46. Each of the arms 44 corresponding to each of the apertures 40 radiates outwardly from the circle 46 of the corresponding aperture 40.

The box 30 is positioned between each of the feet 16. The rod 24 extends through the first lateral side 34 and the second lateral side 36 of the box 30 such that the box 30 is coupled to the rod 24. The top side 32 of the box 30 is positioned at a selected angle when the rod 24 is rotated in the feet 16. The first lateral side 34 has a first well 48 extending toward the second lateral side 36. Additionally, the first lateral side 34 has a second well 50 extending toward the second lateral side 36.

A plurality of pegs 52 is provided and each of the pegs 52 is selectively inserted into a selected one of the apertures 40 in the box 30. Each of the pegs 52 comprises a head 54 that has a first surface 56 and a second surface 58. The second surface 58 is concavely arcuate with respect to the first surface 56 such that the head 54 has a hemispherical shape. Moreover, the second surface 58 has a flattened portion 60. The head 54 corresponding to each of the pegs 52 may have a variety of diameters with respect to each other.

Each of the pegs 52 includes a stem 62 that is coupled to and extends away from the first surface 22 of the head 54. The stem 62 has an outer surface 64 and the outer surface 64 has a lobe 66 extending outwardly therefrom. Moreover, the lobe 66 extends along an entire length of the stem 62. The stem 62 is positioned in the circle 46 of a selected one of the apertures 40 and the lobe 66 is positioned in a selected one of the arms 44 of the selected aperture 40. In this way the stem 62 is inhibited from rotating in the selected aperture 40.

A first drawer 68 is slidably positioned within the first well 48 and a second drawer 70 is slidably positioned within the second well 50. Each of the pegs 52 is selectively stored in the first 68 and second 70 drawers. A plurality of balls 72 is provided and a selected one of the balls 72 is selectively thrown against the box 30. Each of the balls 72 is comprised of a resiliently compressible material such that the balls 72 bounces from the box 30. The selected ball 72 randomly strikes the pegs 52 that are positioned on the box 30 thereby altering an angle of deflection of the ball 72 with respect to the top side 32 of the box 30. In this way the pegs 52 inhibit the user from guessing the angle of deflection of the ball 72 thereby enhancing hand eye coordination.

Additionally, the varying sizes of heads 54 on the pegs 52 facilitates a variety of angles of deflection with respect to the selected ball 72 to increase difficulty of catching the selected ball 72.

In use, the feet 16 are positioned on the support surface 14 and a selected number of the pegs 52 are positioned in selected apertures 40. The pegs 52 may be randomly distributed on the box 30 and the pegs 52 may be arranged to form a selected pattern on the box 30. Moreover, the lobe 66 on each of the pegs 52 is positioned in a selected one of the arms 44 in the selected aperture. In this way the flattened portion 60 on the head 54 corresponding to each of the pegs 52 may be pointed in varying directions.

A first player bounces the ball 72 against the top side 32 of the box 30. The ball 72 deflects from the box 30 in random directions when the ball 72 strikes the head 54 corresponding to each of the pegs 52 and the flattened portion 60 corresponding to each of the pegs 52. In this way a second player is inhibited from guessing the deflection of the ball 72 thereby enhancing hand eye coordination when the second player tries to catch the ball 72 after the ball 72 is deflected. The ball 72 is continuously bounced back and forth between the first end second players. Additionally, the box 30 is tilted at a selected angle to increase a difficulty of catching the ball 72 when the ball 72 is bounced off of the box 30.

With respect to the above description then, it is to be realized that the optimum dimensional relationships for the parts of an embodiment enabled by the disclosure, to include variations in size, materials, shape, form, function and manner of operation, game and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A sports agility game being configured to have a ball bounced thereon at random angles thereby training hand eye coordination in a user, said game comprising:
a base being configured to be positioned on a support surface;
a box being pivotally coupled to said base such that said box is selectively positioned at a selected angle;
a plurality of pegs, each of said pegs being selectively inserted into a selected one of said apertures in said box; and
a ball being selectively thrown against said box, said ball being comprised of a resiliently compressible material such that said ball bounces from said box, said ball randomly striking said pegs that are positioned on said box thereby altering an angle of deflection of said ball with respect to said box wherein said pegs are configured to inhibit the user from guessing the angle of deflection of said ball thereby enhancing hand eye coordination.

2. The game according to claim 1, further comprising said base comprises a pair of feet, each of said feet having a bottom edge and a first surface, said bottom edge corresponding to each of said feet being configured to abut the support surface.

3. The game according to claim 2, further comprising a rod rotatably extending through each of said feet such that said feet are spaced apart from each other having said first surface corresponding to each of said feet being directed toward each other, said rod having a first end, said rod extending through an associated one of said feet such that said first and is exposed.

4. The game according to claim 3, further comprising a knob being threadably coupled to said first end of said rod wherein said knob is configured to be manipulated, said knob frictionally engaging said associated foot when said knob is tightened thereby retaining said rod at a selected point of rotation in said feet.

5. The game according to claim 1, wherein said box has a top side, a first lateral side and a second lateral side, said top side being recessed to define a lip extending around a perimeter of said top side, said top side having a plurality of apertures extending into an interior of said box, said apertures being spaced apart from each other and being distributed on said box.

6. The game according to claim 5, wherein each of said apertures has a bounding surface, said bounding surface corresponding to each of said apertures defining a plurality of arms and a circle, each of said arms corresponding to each of said apertures radiating outwardly from said circle of said corresponding aperture.

7. The game according to claim 5, wherein:
said base includes a pair of feet and a rod rotatably extending between said feet; and
said box is positioned between each of said feet having said rod extending through said first lateral side and said second lateral side of said box such that said box is coupled to said rod, said top side of said box being positioned at a selected angle when said rod is rotated in said feet.

8. The game according to claim 5, wherein said first lateral side has a first well extending toward said second lateral side.

9. The game according to claim 5, wherein said first lateral side has a second well extending toward said second lateral side.

10. The game according to claim 1, wherein each of said pegs comprises a head having a first surface and a second surface, said second surface being concavely arcuate with respect to said first surface such that said head has a hemispherical shape, said second surface having a flattened portion.

11. The game according to claim 10, further comprising a stem being coupled to and extending away from said first surface of said head, said stem having an outer surface, said outer surface having a lobe extending outwardly therefrom, said lobe extending along an entire length of said stem.

12. The game according to claim 11, wherein:
said box has a plurality of apertures, each of said apertures having a circle and a plurality of arms; and
said stem is positioned in said circle of a selected one of said apertures having said lobe being positioned in a selected one of said arms of said selected aperture such that said stem is inhibited from rotating in said selected aperture.

13. The game according to claim 8, further comprising a first drawer being slidably positioned within said first well, said pegs being selectively stored in said first drawer.

14. The game according to claim 8, further comprising a second drawer being slidably positioned within said second well, said pegs being selectively stored in said second drawer.

15. A sports agility game being configured to have a ball bounced thereon at random angles thereby training hand eye coordination in a user, said game comprising:
a base being configured to be positioned on the support surface, said base comprising:
a pair of feet, each of said feet having a bottom edge and a first surface, said bottom edge corresponding to each of said feet being configured to abut the support surface,
a rod rotatably extending through each of said feet such that said feet are spaced apart from each other having said first surface corresponding to each of said feet being directed toward each other, said rod having a first end, said rod extending through an associated one of said feet such that said first and is exposed, and
a knob being threadably coupled to said first end of said rod wherein said knob is configured to be manipulated, said knob frictionally engaging said associated foot when said knob is tightened thereby retaining said rod at a selected point of rotation in said feet;
a box being pivotally coupled to said base such that said box is selectively positioned at a selected angle, said box having a top side, a first lateral side and a second lateral side, said top side being recessed to define a lip extending around the perimeter of said top side, said top side having a plurality of apertures extending into an interior of said box, said apertures being spaced apart from each other and being distributed on said box, each of said apertures having a bounding surface, said bounding surface corresponding to each of said apertures defining a plurality of arms and a circle, each of said arms corresponding to each of said apertures radiating outwardly from said circle of said corresponding aperture, said box being positioned between each of said feet having said rod extending through said first lateral side and said second lateral side of said box such that said box is coupled to said rod, said top side of said box being positioned at a selected angle when said rod is rotated in said feet, said first lateral side having a first well extending toward said second lateral side, said first lateral side having a second well extending toward said second lateral side;
a plurality of pegs, each of said pegs being selectively inserted into a selected one of said apertures in said box, each of said pegs comprising:
a head having a first surface and a second surface, said second surface being concavely arcuate with respect to said first surface such that said head has a hemispherical shape, said second surface having a flattened portion, and
a stem being coupled to and extending away from said first surface of said head, said stem having an outer surface, said outer surface having a lobe extending outwardly therefrom, said lobe extending along an entire length of said stem, said stem being positioned in said circle of a selected one of said apertures having said lobe being positioned in a selected one of said arms of said selected aperture such that said stem is inhibited from rotating in said selected aperture;
a first drawer being slidably positioned within said first well, said pegs being selectively stored in said first drawer;
a second drawer being slidably positioned within said second well, said pegs being selectively stored in said second drawer; and
a ball being selectively thrown against said box, said ball being comprised of a resiliently compressible material such that said ball bounces from said box, said ball randomly striking said pegs that are positioned on said box thereby altering an angle of deflection of said ball with respect to said box wherein said pegs are configured to inhibit the user from guessing the angle of deflection of said ball thereby enhancing hand eye coordination.
